(19) United States
(12) Patent Application Publication
(10) Pub. No.: US 2018/0163096 A1
(43) Pub. Date: Jun. 14, 2018

(54) DRY FUNCTIONAL COATING TAPE

(71) Applicant: Intertape Polymer Corp., Sarasota, FL (US)

(72) Inventors: Sanjeev Singh, Saint Laurent (CA); Ronald J. Horwitz, Palm Harbor, FL (US)

(21) Appl. No.: 15/840,333

(22) Filed: Dec. 13, 2017

Related U.S. Application Data
(60) Provisional application No. 62/433,573, filed on Dec. 13, 2016.

(51) Int. Cl. C09J 7/50; C09J 7/10

(52) U.S. Cl. CPC C09J 7/50; C09J 7/10

(57) ABSTRACT

Adhesive tapes including dry functional coatings, and method for making the same are provided. An example adhesive tape may include a release liner having an outward-facing, major surface and an inward-facing, major surface. A functional coating layer, in a dry state, may be applied to the inward-facing, major surface of the release liner. An adhesive layer may be directly laminated to the functional coating layer opposite the release liner.

### CROSS-REFERENCE TO RELATED APPLICATIONS

This application claims the benefit of U.S. provisional patent application Ser. No. 62/433,573, filed on Dec. 13, 2016, entitled “Dry Functional Coating Tape,” the entire disclosure of which is incorporated herein by reference.

### TECHNICAL FIELD

The present invention relates to dry functional coatings having an adhesive layer directly applied thereto to form adhesive tapes and/or adhesive sheets, in particular, adhesive tapes having a dry functional coating such as an electrical conductor, insulator or dielectric material, a protective coating, or a print receptive coating, e.g., an ink jet receptive print coating.

### BACKGROUND

Often it may be desirable to apply various coatings to surfaces or objects to serve different functions. Examples of such coatings or functions may include, e.g., conductive coatings, protective coatings, print receptive coatings, and the like. Typically such coatings may be applied as a liquid that can be, e.g., sprayed, brushed, or otherwise applied, to the surface or object. Frequently, such coatings may be desired having a particular shape or configuration, or covering a particular portion of the surface or object. In order to provide the coatings in the desired shape, configuration or on the particular portion of the surface or object, it may be necessary to provide some masking, or protection, surrounding the areas to be coated to prevent inadvertently applying the coating to undesired portions of the surface, or in shape or configurations that do not match the desired shape or configuration. Applying such masking can be a time consuming task, and may require the use of special materials that may add to the expense of applying the coatings. Similarly, applying the coating may require specialized equipment (such as special spraying equipment) and may be required to be applied to specially trained individuals. Furthermore, particularly in the case of sprayed coatings, various environmental concerns must be considered, such as containment of overspray, containment of solvents, etc. As such, depending upon the coating material and the requirements of the coating, providing such desired functional coatings may often be time consuming an expensive.

### SUMMARY OF THE DISCLOSURE

According to an implementation, an adhesive tape may include a release liner having an outward-facing, major surface and an inward-facing, major surface. The adhesive tape may include a functional coating layer, in a dry state, applied to the inward-facing, major surface of the release liner. An adhesive layer may be directly laminated to the functional coating layer opposite the release liner.

One or more of the following features may be included. The functional coating layer may include an electrically conductive backplane for an electroluminescent lamp. The functional coating layer may include a print receptive coating. The overall thickness of the tape may be between about 1 mil to about 6 mil. The functional coating layer may include a protective coating. The functional coating layer may include one or more of an electrically conductive material, an insulator, and a dielectric material.

According to another implementation, an adhesive material may include a release liner having an outward-facing, major surface and an inward-facing, major surface. The adhesive material may also include an adhesive layer applied to the inward-facing, major surface of the release liner. The adhesive material may further include a functional coating layer, in a dry state, directly laminated to the adhesive layer opposite the release liner.

One or more of the following features may be included. The functional coating layer may include a print receptive coating. The functional coating layer may include an electrically conductive backplane for an electroluminescent lamp. The functional coating layer may include a protective coating. The functional coating layer may include one or more of an electrically conductive material, an insulator, and a dielectric material.

According to another implementation, a method of making a laminated tape may include providing an adhesive layer directly applied to a first release liner. A functional coating, in a dry state, may be provided directly applied to a second release liner. The adhesive layer may be laminated directly to the functional coating opposite the second release liner.

One or more of the following features may be included. The method may further include removing either of the first release liner or the second release liner from a respective one of the adhesive layer and the functional coating. The functional coating may include a print receptive coating and removing comprises removing the first release liner. The functional coating may include an electrically conductive backplane for an electroluminescent lamp, and removing comprises removing the second release liner.

Providing the functional coating, in a dry state, directly applied to a second release liner may include coating a liquid functional coating on the second release liner, and drying the liquid functional coating. Providing the adhesive layer directly applied to a first release liner may include coating an adhesive material to the first release liner to form the adhesive layer. The coating of the adhesive material may include one or more of roll coating, knife coating, rod coating, blade coating, spray coating, and curtain coating.

According to another implementation, a method of making a laminated tape may include providing an adhesive layer directly applied to a release liner. The method may also include applying a first liquid functional coating directly to the adhesive layer. The method may further include drying the first liquid functional coating to provide a first functional coating in a dry state laminated directly to the adhesive layer.

In an embodiment, the method may also include applying at least a second liquid functional coating directly to the first functional coating in the dry state. The method may further include drying the second liquid functional coating to provide the second functional coating in a dry state laminated directly to the first functional coating the dry state.

According to yet another implementation, a method of making a laminated tape may include applying a first liquid functional coating to a release liner. The method may also include drying the first liquid functional coating to provide a first functional coating in a dry state. The method may further include applying an adhesive layer directly to the first functional coating in the dry state to provide the adhesive layer directly laminated to the first function coating in the dry state.

In an embodiment, applying the first liquid functional coating to the release liner may include applying a second liquid functional coating to the release liner. The method may also include drying the second liquid functional coating to provide a second functional coating in a dry state. The method may further include applying the first liquid functional coating to the second functional coating in the dry state.

### BRIEF DESCRIPTION OF THE DRAWINGS

FIG. 1 is a perspective view of a roll of a dry functional coating tape having a release liner protecting the dry functional coating, according to an example embodiment.

FIG. 2 is an enlarged transverse view of the tape of FIG. 1 taken along line 2-2, which illustrates the layers the tape, according to an example embodiment.

FIG. 3 is an enlarged transverse view of another embodiment of a tape having a dry functional coating protected by a release liner, according to an example embodiment.

FIG. 4 is a photograph of three samples of example adhesive tape where the dry functional coating is an electrically conductive backplane for an electroluminescent lamp with a release liner protecting the adhesive layer, according to an example embodiment.

FIG. 5 is a photograph of one of the samples from FIG. 4 after removal of the release liner from the adhesive layer, according to an example embodiment.

FIG. 6, is an example embodiment of the adhesive tape of FIG. 1 after application to an adherend and of an electroluminescent paint, which is in the active state, according to an example embodiment.

FIG. 7 is a perspective view of a roll of a dry functional coating tape having a release liner protecting the adhesive layer, according to an example embodiment.

FIG. 8 is an enlarged transverse view of the tape of FIG. 7 taken along line 8-8, which illustrates the layers the tape, according to an example embodiment.

FIG. 9 is photograph of a sample of the embodiment of FIG. 7 as a 8×11 sheet where the dry functional coating is an ink receptive print coating with a release liner protecting the adhesive layer, according to an example embodiment.

### DETAILED DESCRIPTION OF EXAMPLE EMBODIMENTS

The following detailed description will illustrate the general principles of the disclosure, examples of which are additionally illustrated in the accompanying drawings. In the drawings, like reference numbers indicate identical or functionally similar elements. It will be appreciated that other embodiments and implementations, beyond what is described herein, may be achieved consistent with the concepts of the present disclosure.

In general, the present disclosure may provide tapes, or adhesive materials, include dry, functional coatings having an adhesive directly laminated to at least one major surface of the dry, functional coating. The dry, functional coatings may, in some implementations, include coatings of a variety that may typically be applied to substrates as a liquid. According to some implementations, the tapes and/or adhesive material may allow the functional coatings to be selectively applied to portions of a substrate and/or to be applied to portions of the substrate in specific configuration, while reducing and/or eliminating the expense, waste, mess, and/or labor that may typically be associated with applying coating from a liquid material. For example, providing the functional coatings in a dry form may reduce and/or eliminate the need for masking the substrate to apply to coating to desired regions and/or in desired configurations, and the need for applying the liquid coating, e.g., via brushing, spraying, or the like. The present disclosure may further generally relate to methods for producing such tapes and/or adhesive materials including dry, functional coatings.

In some general implementations, and adhesive may be directly laminated with a dry, functional coating, e.g., such that the functional coating, in a dry form, may be directly adhered to a substrate (e.g., to a desired region of a substrate and/or in a desired configuration on the substrate). For example, the dry, functional coating, having the adhesive directly laminated thereto, may be cut to desired sizes, shapes, and/or configurations prior to being applied to the substrate. In some implementations, two or more functional coatings may be directly laminated to one another, and the adhesive may be directly laminated to an outer major surface of one of the dry, functional coatings. Consistent with some such embodiments, the tape and/or adhesive material may include an arrangement of functional layers that may be applied to a substrate (e.g., via the adhesive directly laminated with one or the functional layers) as a single structure. Various additional and/or alternative configurations will be appreciated from the following description of illustrative embodiments.

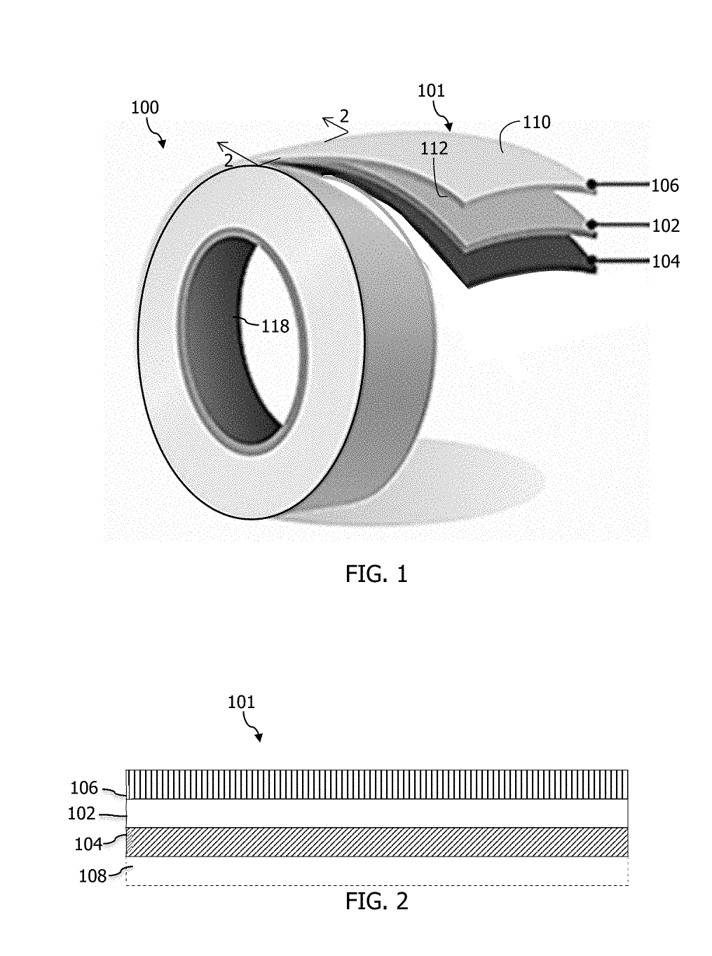

With reference to the drawings, FIG. 1 illustrates an example embodiment of a roll 100 of adhesive tape 101 wound onto a core 118. Referring to FIGS. 1 and 2, from top to bottom relative to the page, the adhesive tape 101 may include a release liner 106 having an outward-facing, major surface 110 and an inward-facing, major surface 112, where inward is toward the core 118, a functional layer 102, in the dry state, coated on the inward-facing, major surface 112 of the release liner 106, and an adhesive layer 104 directly laminated to the dry functional layer 102 opposite the release liner 106.

In some embodiments, this three-layered structure may utilize a differential order dual release liner 106, and a sacrificial release liner 108 (see FIG. 2) that may have been removed, post-lamination of the adhesive layer 104, coated on the sacrificial release liner 108, to the dry functional coating 102 with its release liner 106. For example, the sacrificial release liner 108 may be peelable from the adhesive layer 104 without disturbing the bond between the adhesive layer 104 and the dry functional coating 102. This liner is referred to as “sacrificial” because after the tape is formed, the release liner 108 may be removed and discarded. However, if desired, release liner 108 could be left in place and removed by the end user after removing a segment of tape from a roll.

Further, depending upon how the tape is wound onto the core 118, in some implementations the release liner 108 may remain adhered to the adhesive layer 104 through the process as the differential liner and the release liner 106 may be the sacrificial release liner as it is described above, i.e., the release line that may be discarded after lamination of the adhesive layer 104 to the dry functional coating 102.

The release liner 106 may include an outward-facing, major surface 110 that may have a higher order release than the inward-facing, major surface 112, which may allow for a generally smooth unwind of the adhesive layer 104 from the release liner 106 on roll 100, without disturbing the bond between the adhesive layer 104 and the dry functional layer 102. The adhesive layer 104 and the functional coating 102 may stay permanently bonded as an integral unit post-lamination, and, in some embodiments, throughout the tape's life. After a piece of the tape from roll 100 is applied to a surface, the release liner 106, which is now the portion closest to the user, can be peeled away from the functional coating 102 by the user. Removing this release liner may leave the functional coating 102 adhered to the selected surface.

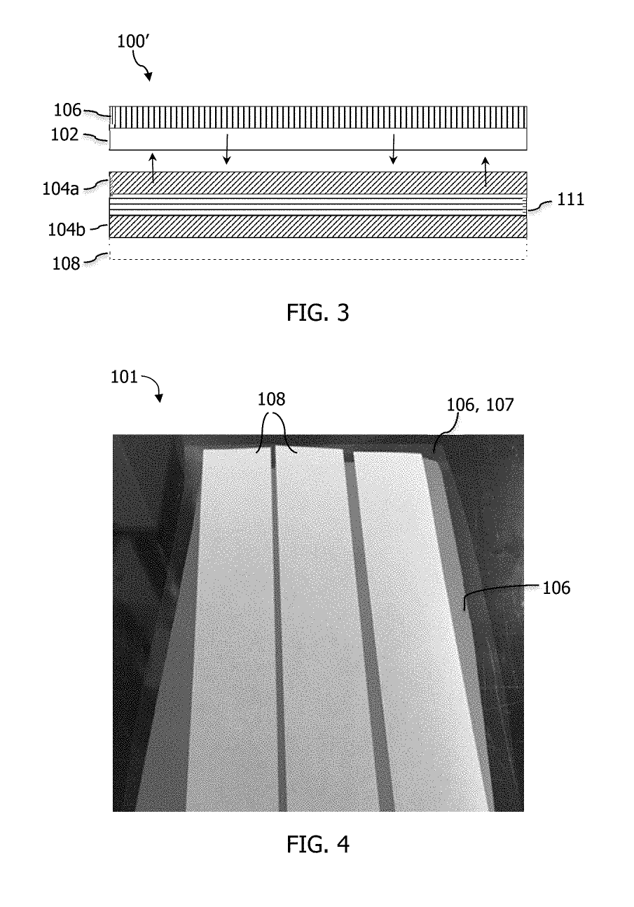

Referring to FIG. 3, in another example embodiment, the adhesive layer 104 may include a double coated tape with a carrier 111 between two adhesive layers 104a and 104b to provide additional dimensional stability to the finished laminated adhesive tape.

Lamination

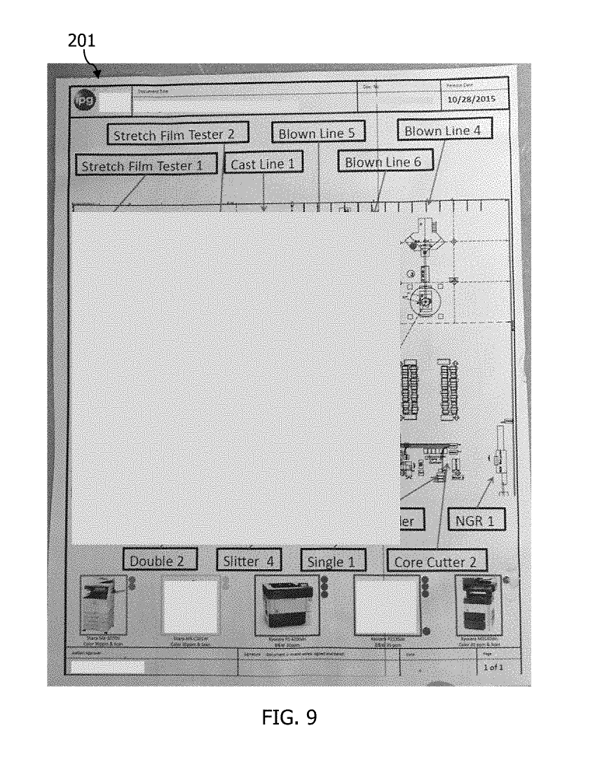

As generally discussed above, the functional coating may generally include a coating of a material to provide some functional performance characteristics, such as a conductive layer, a print receptive layer, a protective coating, etc., to a substrate, or item, once applied thereto. The functional coating may generally be of a variety that may conventionally be applied to the substrate, or item, as a liquid, which may subsequently dry or cure to provide a solid coating. Utilizing FIG. 3 for descriptive purposes of one particular embodiment, the functional coating may be applied to release liner 106 with the functional coating in a liquid sate. The functional coating may then be allowed to dry, or cure (depending upon the nature of the functional coating). Accordingly, the functional coating 102, now in a dry state, may be disposed on release liner 106. Continuing with such an example embodiment, an adhesive tape 101 (see FIG. 4) or an adhesive sheet 201 (see FIG. 9) may be made by laminating the functional layer 102, in the dry state, on its release liner 106 directly to an adhesive layer 104a, which may be adhered on its release liner 108. With the functional coating 102 directly laminated to the adhesive layer 104a, the release liners 106, 108 may form the outermost surfaces of the laminate. In the illustrative example of FIG. 3, release liner has been depicted with dashed lines to indicate that release liner 108 may be removed after the lamination is complete. Consistent with such an embodiment, release liner 108 may typically not be included as part of the final product sold to the consumer. In such an embodiment, release liner 108 may be referred to as a sacrificial liner. However, in some example embodiments, roles of the release liners may be reversed, maintaining release liner 108 adhered to adhesive layer 104b, and making release liner 106 the sacrificial release liner, e.g., which may be discarded after lamination of the layers. In some such embodiments, only one release liner may be needed to facilitate winding the tape in to a roll of adhesive tape. With release liner 108 removed after lamination (pre-end-user), the tape product is “live” and will stick to any surface. With release liner 108 in place, test fittings to a surface can occur, e.g., as release liner 108 may prevent the tape from sticking to the surface. Once a user is satisfied with the test fittings, release liner 108 may be removed to allow the tape to be adhered to the desired surface.

The lamination is represented in FIG. 3 by the arrows directing the functional layer 102 toward the adhesive layer and vice versa. In some example implementations, the lamination process may be a continuous method of manufacturing, where the two subtapes (e.g., a substape including the functional layer adhered on release liner 106 and a subtape including the adhesive layer 104 adhered on release liner 108) may be fed into contact with one another as described. In some embodiments, the lamination process may include, separate coating sections for the application of each of the functional coating and the adhesive material on its respective release liner upstream of the actual lamination of the two subtapes to one another. Subsequent to the coating of the functional coating on to the release liner, but upstream of the lamination process, a drying process may be present to dry or cure the functional coating to the dry state. In an example embodiment, the drying process may include passing the subtape through an oven, past circulating air and/or an electron beam source, or other means of drying and/or curing the coating of the functional layer. As will be described in detail below, additional and/or alternative processes for providing the tape and/or adhesive material including the dry functional coating may be implemented.

Release Liner

The release liners 106 and 108 may both be release papers or films, or one may be a release paper and one by be a film, or an altered exterior surface providing differential release characteristics thereto. The paper or film may have a silicon release coating or a wax coating providing it with release properties. In another embodiment, the release paper or films may have a thermoplastic polymer surface rendering the release liner peel able away from the adhesive layer or the functional coating. In one embodiment, the release liner may have a microstructured and/or macrostructured pattern that may impart a desired pattern to the liner followed by the application of a silicone release coating or a wax release coating, or by pressing a pattern into a thermoplastic polymer surface, with or without a silicone release coating. Accordingly the adhesion between the release liners 106, 108 and the respective functional coating layer 102 and adhesive layer 104 may be varied. In another embodiment, rather than a separate release liner, the functional layer may have an altered exterior surface, for example, a Corona treated exterior surface, which may make the surface energies different on each side to promote differential adhesion levels (e.g., as between the release liner 106 and the adhesive layer 104).

Adhesive Layer

Consistent with the example embodiment discussed above, the adhesive layer 104 may be applied to the release liner 108 as one or more of solvent-cast, aqueous, solventless, or molten films or as an extrusion coating using any manner of roll, knife, rod, or blade coating, curtain coating, gravure cylinder, slot die coating or other suitable methods. In some embodiments, the adhesive layer 104 may be cross-linked by means of heat or radiation. Consistent with some example embodiments, the adhesive layer 104, whether a PSA or a permanent adhesive, may be applied to the release liner 108 at a thickness in the range of about 0.1 mil to about 3 mil, more preferably about 0.5 mil to about 1.5 mil.

Pressure sensitive adhesives (PSA) may include elastomeric-based adhesives that “wet out” at room temperature. When pressure is applied to the adhesive, it may become flowable, thereby covering the substrate. As the pressure is removed, adhesion may take place. Typical varieties of PSAs are derived from natural rubber, synthetic rubber, acrylic, silicone and modifications thereof. The following adhesive compounds, solutions, or emulsions may be used, either alone or in combination, without departing from the scope of this invention. Suitable rubber-based adhesives may include, but are not limited to, natural rubber, synthetic polyisoprene, styrene-isoprene-styrene block copolymer (SIS), styrene-butadiene-styrene block copolymer (SBS), styrene-isoprene-butadiene-styrene block co-polymer (SIBS), styrene-ethylene-butylene-styrene block co-polymer (SEBS), styrene-ethylene-propylene-styrene block copolymer (SEPS), styrene butadiene rubber, nitrile rubber, neoprene rubber, butyral and butyl rubber, polyisobutylene, polysulfide rubber, silicone rubber, natural latex rubber, and synthetic latex rubber. Suitable resin-based adhesives may include, but are not limited to, polyvinyl acetate, polyvinyl butyral, polyvinyl chloride, acrylic, ethylene vinyl acetate, polyethylene-based, polyolefin-based, nylon-based, phenol-based (including formaldehyde-based), urea-based (including formaldehyde-based), epoxy resin, polyurethane-based, rosin-based (including rosin esters), polyterpene-based, polyester, petroleum-based, and low-molecular-weight based adhesives. Suitable inorganic adhesives include, but are not limited to, silicate adhesive and wax adhesives such as paraffin, natural wax, and bees wax.

The adhesives disclosed above may include one or more additives such as tackifiers (resins), plasticizers, fillers, pigments, ultraviolet (UV) absorbers, light stabilizers, aging inhibitors, crosslinking agents, and crosslinking promoters. Tackifiers may include, for example, hydrocarbon resins (for example, those of unsaturated C₅ or C₇ monomers), terpene-phenolic resins, terpene resins formed from raw materials such as α- or β-pinene, aromatic resins such as coumarone-indene resins or resins of styrene or α-methylstyrene, such as rosin and its derivatives, such as disproportionated, dimerized or esterified resins, in which context it is possible to use glycols, glycerol, or pentaerythritol. Particularly suitable are aging-stable resins without an olefinic double bond, such as hydrogenated resins, for example.

Examples of suitable fillers and pigments may include, but are not limited to, carbon black, titanium dioxide, calcium carbonate, zinc carbonate, zinc oxide, silicates or silica.

Examples of suitable plasticizers include aliphatic, cycloaliphatic, and aromatic mineral oils, diesters or polyesters of phthalic acid, trimellitic acid or adipic acid, liquid rubbers (for example, nitrile rubbers or polyisoprene rubbers), liquid polymers of butene and/or isobutene, acrylic esters, polyvinyl ethers, liquid resins and plasticizer resins based on the raw materials for tackifier resins, wool wax and other waxes, or liquid silicones.

Examples of crosslinking agents may include, but are not limited to, phenolic resins or halogenated phenolic resins, melamine resins and formaldehyde resins. Examples of suitable crosslinking promoters are maleimides, allyl esters such as triallyl cyanurate, polyfunctional esters of acrylic and methacrylic acid, and polyfunctional aziridines.

A permanent adhesive may include an adhesive that is intended to permanently bond together two objects, which typically provides a high adhesive force preventing easy mechanical debonding of the adhesive from one or both of the two objects. For example, a permanent adhesive may be used to affix the adhesive tape to an automobile, marine vessel, or aircraft for further application of electroluminescent paint. According to some embodiments, a permanent adhesive may include one that can withstand environmental conditions which an automobile or aircraft may encounter during operation, such as temperature changes, wind, chemicals such as salt, etc. A permanent adhesive may include a polymer system. Examples of permanent adhesives may include, but are not limited to, epoxide, polyimide, and silicone based compositions.

Dry Functioning Coating

As generally discussed above, a dry functional coating may include a coating that may be applied to provide some particular functionality, such as conductivity, insulation, dielectric character, print receptivity, luminescence, protection (e.g. to environmental conditions such as corrosion, etc.) to a substrate or article. Typically, the dry functional coating may include a material that is applied as a liquid, and which may subsequently dry or cure. For example, the functional coating material may include a solvent-based material, and aqueous-based material, and/or a chemically settable material, which may be applied as a liquid, and which may subsequently dry or set to provide a dry, solid layer or coating. Various examples of functionality that may be provided by such materials and/or coatings of such materials and example application will be discussed below. However, it should be understood that such examples are intended for the purposed of illustration, and not of limitation. Various additional coatings, materials, functionalities, and applications may be utilized and/or achieved in connection with the present disclosure.

Conductive Backplane

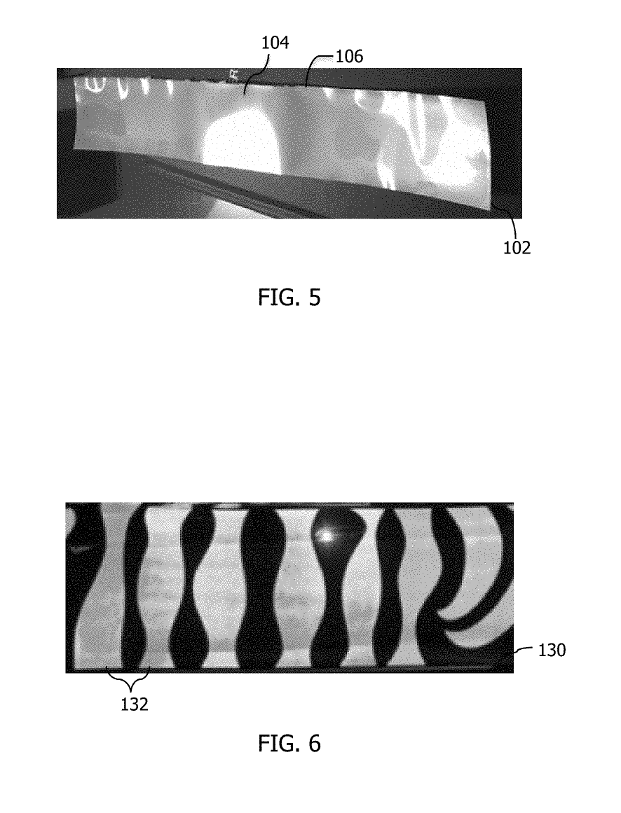

Referring also to FIGS. 4-6, in an illustrative example embodiment the tape 101 include a conductive backplane 107 as the functional coating layer 106 (a clear film looking layer) and a single layer of adhesive 104 directly laminated thereto. The conductive backplane 107 may form the bottom electrode of an electroluminescent lamp, e.g., such as taught in U.S. Pat. No. 8,470,388 and published U.S. Patent Application Publication No. 2013/0171754, portions of which are reproduced below. The material selected for the conductive backplane 107 may be tailored as desired to suit various environmental and application requirements.

In one embodiment the conductive backplane 107 may be made using a highly conductive, generally opaque material. Examples of such materials include, without limitation, an alcohol/latex-based, silver-laden solution such as SILVASPRAY™ available from Caswell, Inc. of Lyons N.Y., and a water-based latex, copper-laden solution such as “Caswell Copper” copper conductive paint, also available from Caswell, Inc. In one embodiment a predetermined amount of silver flake may be mixed with the copper conductive paint. As an alternative to either Caswell SILVASPRAY™ or Caswell Copper, silver flake may be mixed in a solution of an aqueous-based styrene acrylic co-polymer solution (discussed further below) and ammonia to encapsulate the silver for application to a prepared surface (i.e., substrate) as a backplane material.

Conductive backplane 107 may also be an electrically conductive, generally clear layer such as, without limitation, “CLEVIOS™ S V3” and or “CLEVIOS™ S V4” conductive polymers, available from Heraeus Clevios GmbH of Leverkusen, Germany. This configuration may be preferred for use with target items having generally transparent substrates, such as glass and plastic, and for embodiments where a thinner total application of layers for an electroluminescent lamp is desired.

As disclosed in the patent references noted above, the conductive backplane material may typically be provided as a sprayable conductive material that is painted on to a surface. The entire process of spraying the various layers, which may all be solvent based materials, on to a surface to form the electroluminescent lamp may require specialized equipment, and a trained professional artist to correctly apply the same to automobiles and airplanes, for example. The backplane material may be a crucial layer since it has to conduct electricity and have the electrical leads connected thereto. Moreover, the conductive backplane is typically the thinnest layer of the structure and has tight tolerances to be able to effectively allow even light distribution. Accordingly, in typical processes applying the conductive backplane for the electroluminescent lamp may be a complex and time consuming process that is typically carried out be specially trained individuals.

Consistent with example embodiments of the present disclosure, the ability to utilize a tape of backplane material as disclosed herein that is provided having a desired shape or that can be cut or pre-cut to a desired shape for application to a surface may greatly simplify the process, especially one of the more difficult steps of the prior application process. Moreover, the backplane tape may define the area to which the additional dielectric, phosphor containing, conductive clear layer, and top coat layers may be applied. As shown in FIG. 6, the surface to which the tape disclosed herein may be applied may include a panel of an automobile 130. The tape may be the base layer of the electroluminescent lamps 132. Example tapes disclosed herein may result in a product suitable for consumers, professional installers or OEM manufacturers to apply, and may provide a functional coating surface without the need for any liquid based or spray coatings. Additionally, the use of tape may reduce and/or eliminate the need of to mask the surface before the application operation, and cleaning after the application operation. This improvement may result in saving time, cost and effort for the application of the electroluminescent lamps.

Furthermore, coating the conductive backplane material onto the release liner, in some example embodiments, may provide control and accuracy for laying down a thin, conformable film of the material (in contrast to variations that are present in spray coatings). For example, applying the conductive backplane material to the release line in a uniform layer of a desired thickness may be readily achievable during a tape manufacturing process, as compared to a spraying or painting operation in the field (e.g., when the electroluminescent lamp is being formed on the panel or other surface). In some embodiments, the tape may also include the dielectric layer of the electroluminescent lamp applied over the functional layer, i.e., the conductive backplane layer, as an outer surface of the tape, which may be protected by a release liner removable by the end user. The adhesive tape 101 may alternately have the following functional layers in the following order backplane, dielectric, and phosphor layer, and may optionally include a bus bar layer as disclosed in the patents for the electroluminescent lamps. If the bus bar layer is included it will connect to the backplane through a pattern (zone) coat process. For example, the conductive backplane material may be coated onto at least a portion of a release liner and subsequently dried. Once the conductive backplane material has dried, a dielectric material may be coated onto at least a portion of the conductive backplane material and/or at least a portion of the conductive backplane material and the release liner. The dielectric material may be subsequently dried. Once the dielectric material has dried, a phosphor material may be coated onto the dielectric material and/or at least a portion of one or more of the dielectric material, the conductive backplane, and the release liner. The phosphor material may be subsequently dried to provide a multi-layer tape of dry functional coatings. The multi-layer arrangement of backplane, dielectric, and phosphor material may subsequently be laminated with an adhesive layer to provide the multi-layer adhesive tape. It will be appreciated that the order and/or arrangement of layers may vary as desired. For example, in an embodiment, the phosphor layer may be applied to at least a portion of the release liner, the dielectric layer may be applied to at least a portion of the phosphor layer and/or release liner, and the conductive backplane may be applied to at least a portion of the dielectric layer, the phosphor layer, and/or the release liner. The adhesive may be laminated directly to the conductive backplane (and/or any exposed portions of the other layers), and/or the adhesive may be laminated directly to the phosphor layer (e.g., after removal of the release liner). Other configurations will also be recognized as being within the scope of the present disclosure.

In some implementations, the adhesive tape 101 may be used for painting cost effective graphic designs on a surface. The tape 101 may typically be applied from the adhesive side and the backing/release liner 106 (if present) may be taken off after applying the tape; thus, positioning the coated functional layer facing the user. The functional coating layer on the tape may be dry at the time of use of the tape, and may remain dry throughout the application process performed by the user. Therefore, a masking operation can be completely avoided for the application process of an electroluminescent lamp. The tape can also be used for straight or curved distinct demarcations required during painting operations. This again may save time, effort and cost of expensive masking tapes, which are specifically required for straight clean and distinct appearances. If the tape 101 is less than the full electroluminescent lamp system, i.e., a conductive backplane only or a conductive backplane and a dielectric layer, the user may still need to mask around the system for applying the final steps, but the process may be much easier since the adhesive tape 101 cut to a particular design shape may provide the outline for the area of interest that should be masked.

The conductive backplane material may be coated onto the release liner 106 using traditional methods (roll coating, gravure coating, and curtain coating being the most common). The coating process needs to be carefully controlled to provide a high quality, smooth coating for desirable appearance. The conductive backplane material is a generally a high solid formulation suitable for the coating applications.

Print Receptive Coating

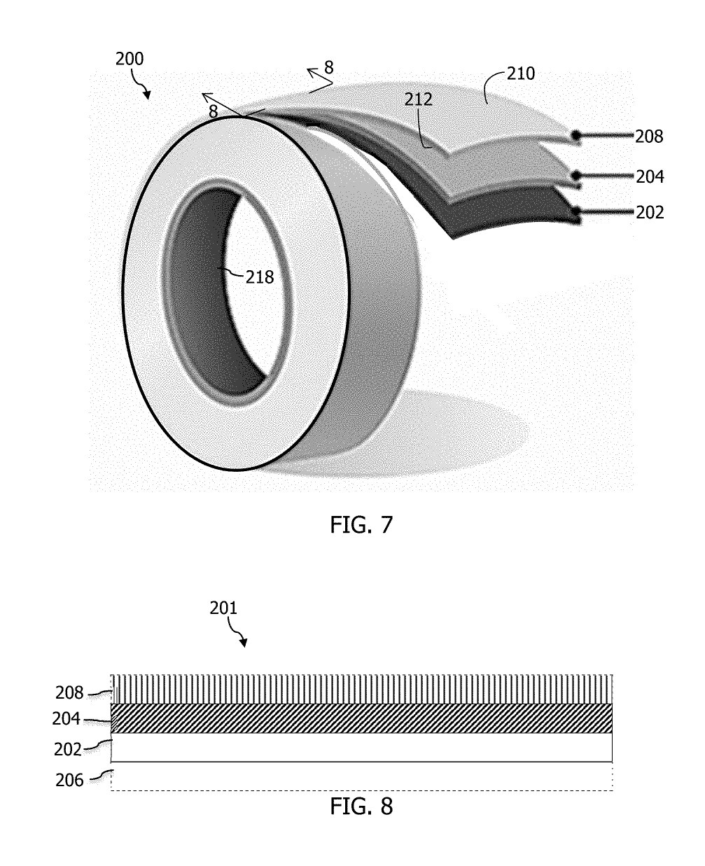

Now turning to FIGS. 7-9, an illustrative example roll 200 of adhesive tape 201 wound onto a core 218 is show. In the example embodiment, the adhesive tape 201 may include, from top to bottom relative to the page, a first release liner 208 having an outward-facing, major surface 210 and an inward-facing, major surface 212, where inward is toward the core 218, an adhesive layer 204 coated on the inward-facing, major surface 212 of the first release liner 208, and a functional layer 202, in the dry state, directly laminated to the adhesive layer opposite the release liner 208. In one particular illustrative embodiment, the functional layer 202 may be a print receptive coating layer. Optionally, as shown in FIG. 8, a second release liner 206 may be present that covers the print receptive coating layer 202. This second release liner 206 may be removed during the manufacturing process of the adhesive tape 201 to provide the self-wound roll 200 of FIG. 7. In such an embodiment, as wound on roll 200, the print receptive coating 202 comes into contact with the first release liner 208. In other embodiments, the second release liner 206 remain in place on the print receptive coating 202 when the tape 201 is wound into roll 200, e.g., to protect the print receptive coating layer 202 until just before printing.

In a similar manner as described above, the functional coating, e.g., in the form of a print receptive coating, may be coated onto the release liner 206, e.g., by gravure coating, slot die coating, or roll coating, or any other suitable coating technique. As also generally discussed above, the print receptive coating may be coated onto the release liner 206 in a liquid state. The thickness of the print receptive coating may be in the range of about 1 to about 2 mils. In an illustrative embodiment, the release liner for the printable coating may be a film, such as a olefinic film, or a smooth paper, such as highly calendared, glassine, or siliconized Kraft paper.

Referring again to the roll 200 of FIG. 7, the three-layered structure may utilize a differential order dual release liner 208, and a sacrificial release liner 206 (see FIG. 8) that may be removed, post-lamination of the adhesive layer 204 (e.g., with its sacrificial release liner 208) to the dry functional coating 202 (e.g., with its release liner 206). In such an embodiment, the sacrificial release liner 206 may be peelable from dry functional coating 202 without disturbing the bond between the adhesive layer 204 and the dry functional coating 202. This liner is referred to as “sacrificial” because after the tape is formed by the lamination of the adhesive layer to the dry functional coating layer, the release liner 206 may be removed and discarded. However, if desired, release liner 206 could be left in place and removed by the end user after removing a segment of tape from a roll just before printing an image on the print receptive coating layer. In alternative embodiments, the release liner 208 may include a sacrificial release liner. For example, after lamination of the adhesive layer (e.g., with its release liner 208) to the dry functional coating 202 (e.g., with its release liner 206), the sacrificial release liner 208 may be removed from the adhesive layer 204, e.g., without disturbing the bond between the adhesive layer 204 and the dry functional coating layer 202. In some such embodiments, a surface of the release liner 206 facing away from the dry functional coating layer 202 may provide a release liner relative to the adhesive layer 204. In such a configuration, the tape 201 may be wound to provide a roll, with the adhesive layer in contact with the side of the release liner 206 facing away from the dry functional coating layer 202. In some such embodiments, the adhesive layer 204 may be separated from the release liner 206 without disturbing the bond between the adhesive layer and the dry functional coating layer 202 to expose the adhesive layer 204 (e.g., to allow adhering the tape 200 to a desired surface). In such an embodiment, the release liner 206 may be removed from the dry functional coating layer 202, e.g., after the tape 200 has been adhered to a desired surface. It will be appreciated that other arrangements and processes may also be utilized.

In some embodiments, the release liner 208 may have an outward-facing, major surface 210 that has a higher order release than the inward-facing, major surface 212, which may allow for a generally smooth unwind of the roll 200, without disturbing the bond between the adhesive layer 204 and the dry functional layer 202. The adhesive layer 204 and the functional coating 202 may stay permanently bonded as an integral unit post-lamination throughout the tape's life. After a piece of the tape from roll 200 is printed with a graphic and/or text, the release liner 208 is removed from the adhesive layer 204 and the adhesive graphic and/or text may be adhered to a selected surface.

Example print receptive coatings for forming the functional layer, in a dry state, may include, but are not limited to, water-based acrylic print receptive coatings. The coatings may configured to be suitable for receiving ink jet or digital printing. Some suitable commercially available print receptive coatings are available from Sun Chemical, Cincinnati, Ohio, and The Lubrizol Corporation, Cleveland, Ohio.

Advantageously, having a print receptive coating directly applied to the adhesive eliminates the need for a substrate or backing typically present in a tape structure, which may reduce the weight and the caliper thickness of the end product. This may produce a thin film for digitally printed graphics that once applied to a surface may be thin enough that there may be virtually no perceptible edge or lip to feel when dragging a hand or finger(s) across a surface. Such thin film adhesive tapes may be useful on aircraft, sea vessels, automobiles, buildings, etc. One particular area where the thin film printable adhesive may be useful is the tail and fuselage sections of an airplane. Complex graphics can be relatively easily applied since no masking of the area is required.

Other Dry Functional Coatings

In another embodiment, the dry functional layer may provide a protective layer for transportation or machinery to cover and seal damaged areas to prevent rust development or propagation and eliminate the need for traditional repainting of damaged areas. The protective coating could also be a hydrophobic layer that would allow a user to seal a crack or joint without liquid material application via roller or spray. In the former, the functional layer could be an acrylic, alkyd, epoxy or urethane chemistry from manufacturers such as Sherwin-Williams and Hentzen Coatings. In the latter, the chemistry of the functional coating could be butyl rubber, formulated acrylic or polyolefin emulsions.

In another embodiment, a functional coating could be an electrically conductive or electrically insulating material that can be applied to a surface in the dry state (e.g., as the tape including a dry functional coating layer) and eliminate the need for liquid application. This functional layer may include a coating of zinc, aluminum or magnesium to allow for a cathode protection in an electrolytic corrosion protection system. A thin rubber (such as PLASTI DIP®) could be used as a functional insulator layer.

In various embodiments, the tape may include two or more functional layer in series on top of one another such that the layer may be functionally active independently and/or may be active in combination with one another functional layer. For example, in an electroluminescent lamp structure, the functional layers may include a conductive backplane, a dielctric, and a phosphor layer, all must function together to electroluminate the tape. In another example, an electrolytic corrosion protection tape structure, a sacrificial functional layer (e.g., a Zn, Mg, or Al layer) and the adhesive layer (i.e., that may be conductive) may function together to allow the movement of charge through the adhesive layer from sacrificial layer to the protecting surface. In addition/as an alternative to two or more functional layers in series on top of one another, two or more functional coatings may be arranged at least partially adjacent to one another (e.g., on a common layer). Further, in some embodiments, two or more functional coating layers may be arranged at least partially in series (e.g., with at least one layer at least partially overlying another layer) and at least partially adjacent to one or more other layers.

Consistent with the various embodiments described herein, the functional layer may include a coating that may be applied as a liquid, and may be subsequently dried and/or cured to provide a dry functional coating (e.g., in solid state). Accordingly, a functional coating may be provided to a desired surface and/or object in dry form, which may eliminate the need to coat the surface and/or object with a liquid coating. As discussed above, by eliminating the need to coat the surface and/or object with a liquid coating, the mess, time, expense, and specialized training that may be required to appropriately mask appropriate areas and/or surface of the object, provide containment (e.g., against over spray and/or environmental concerns associated with the liquid coating), handling of liquid coatings, and clean-up following coating of the surface and/or object may be reduce, or completely eliminated. Additionally, complex graphics may be more easily applied, e.g., by precutting the tape to desired shapes prior to application. Such precutting of the tape may include precutting of the tape using CNC and/or die cutting equipment prior to delivery of the tape to a final end user (e.g., an individual who may actually apply the tape to and object or surface). Various additional features and/or advantages may also be realized.

In some embodiments, providing the adhesive laminated directly to the dry functional coating layer, the overall thickness and/or weight of the tape (and/or adhesive material) may be reduced and/or conformability of the tape (and/or adhesive material) may be increased. In some embodiments, such features may be provided and/or enhanced by eliminating the use of a separate substrate disposed between the dry functional coating layer and the adhesive layer. In some embodiments, the overall thickness from the combination of the adhesive layer and one functional coating layer, for all of the embodiments disclosed herein, may be in the range of about 1 mil to about 6 mil, and for example in the range of about 2 mil to about 5 mil. It will be appreciated that other thicknesses may be utilized, e.g., depending upon the requirements for the functional coating, the number of dry functional coating layers included in the tape, as well as various design considerations.

### EXAMPLE 1

Referring to the photographs in FIGS. 4-6, a conductive backplane tape may be produced by laminating a dry layer of a functional coating on a first releaser liner to an adhesive layer coated on a second release liner with the adhesive layer in direct contact with the dry functional coating. Here, the layer of functional coating, which may be the closest to/facing the user at end use, may be coated directly to a first release liner. The functional coating may be one or more of a conductive backplane layer, a dielectric layer, and a phosphor layer, but in the illustrative embodiment the functional coating may only include a conductive backplane layer. The composition for the conductive backplane layer may be used as supplied from the manufacturer, but could be diluted with solvent to promote a smooth level coating. The coating (typically 0.5 to 1.0 mil) may be applied to the first release liner using known coating methods and may be dried with heated air. Based on the configuration of the coater, subsequent layers (dielectric material and/or phosphor material) may be either coated sequentially (e.g., onto to the dried conductive backplane layer) and dried before application of the next layer (e.g., onto the dried previously coated layer), or the material may be rolled up and then passed through the coating machine again for each subsequent coating step.

Separately, an adhesive layer may be coated on a second release liner. In one embodiment, that adhesive forming the adhesive layer may include a waterborne acrylic PSA or a solvent-borne acrylic PSA. The adhesive can be coated via a roll coater, a wire wound rod, a slot die or a gravure coater to a thickness in the range of about 0.8 mil to about 5 mil, for example to a thickness in the range of about 1.5 mil to about 3.0 mil. This adhesive-release liner unit may be placed into a lamination station and married to the finished dry functional coating-release liner unit (e.g., with the adhesive layer directly contacting the dry functional coating layer) and run through a nip roller to ensure uniform contact between the adhesive layer and the dry functional coating layer. The finished adhesive tape may be wound on to a roll for later processing.

### EXAMPLE 2

Referring to FIG. 9, an illustrative embodiment of a printable adhesive in sheet form 201 is shown with text and images printed thereon. The sheet of printable adhesive 201 may be formed by coating a printable coating composition directly onto a film release liner at a thickness of 1-2 mils and, subsequently, drying the printable coating composition. The printable coating may be applied to the release liner by gravure coating, and/or via any other suitable coating process. The printable coating composition may include a coating composition purchased from The Lubrizol Corporation. The coating may be dried using a forced air oven, and/or other suitable drying equipment or arrangement. This subtape may be wound into a roll for further processing at a later time, and/or the subtape could be made in a continuous process where it may be fed to a lamination station in which it is directly laminated to an adhesive subtape.

Separately, an acrylic PSA adhesive may be roll coated onto a siliconized Kraft paper release liner at a thickness of 2-3 mils. The adhesive subtape may be placed into a lamination station and married to the dry functional coating subtape (e.g., by directly laminating the adhesive layer to the dried functional coating layer) and run through a nip roller to ensure uniform contact between the adhesive and the dry functional coating layers. The resulting tape may then be wound to form a roll of tape.

Consistent with the previously described examples, the functional coating material (e.g., in liquid form) may be coated onto a release liner, and may be dried to provide a dry functional coating layer on the release liner. Further, an adhesive may be coated onto another release liner to provide an adhesive layer on the other release liner. The dry functional coating layer (on the first release liner) may then be directly laminated to the adhesive layer (on the second release liner). In some embodiments, one of the first and second release liners may be removed (e.g., as a sacrificial release liner). The remaining release liner may then be removed, e.g., at the time of application of the tape or adhesive material to a desired surface or object by a user. In some further embodiments, rather than being coated onto a separate release liner, the functional coating material may be coated directly onto an adhesive layer. For example, an adhesive material may be coated onto a release liner using a suitable coating process. As appropriate and/or necessary, the adhesive material may be dried, cured, crosslinked, and/or otherwise processed as may be appropriate and/or necessary to provide the adhesive layer on the release liner. Subsequently, the functional coating material may be directly coated onto all, or at least a portion (e.g., to provide a desired configuration of the functional coating), of the adhesive layer using any suitable coating processes. The functional coating material may then be dried and/or cured to provide a dry functional coating layer directly laminated on the adhesive layer. It will be appreciated that the reactivity and/or solubility of the adhesive material and the functional coating material (in a liquid form) may be considered, e.g., to allow for a desired adhesive layer and dry functional coating layer (e.g., without the functional coating material in liquid form undesirably solvating the adhesive and/or adversely reacting with the adhesive material).

In another embodiment, rather than being coated onto a separate release liner, the adhesive may be coated directly onto the dried functional coating layer. For example, the functional coating material (e.g., in a liquid form) may be coated onto all, or at least a portion of, a release liner (e.g., to provide a desired configuration of the functional coating) using any suitable coating process. The functional coating material may then be dried and/or cured to provide a dry functional coating layer directly on the release liner. Subsequently, an adhesive material may be coated onto the dry functional coating layer (e.g., onto at least a portion of the dry functional coating layer and/or at least a portion of the release liner to the extent that the dry functional coating layer may not cover the entirety of the release liner) using any suitable coating process. As appropriate and/or necessary, the adhesive material may be dried, cured, crosslinked, and/or otherwise processed as may be appropriate and/or necessary to provide an adhesive layer directly on (e.g., directly laminated to) the dry functional coating layer. It will be appreciated that the reactivity and/or solubility of the adhesive material (as coated onto the dry functional coating layer) and the dry functional coating layer may be considered, e.g., to allow for a desired adhesive layer and dry functional coating layer (e.g., without the adhesive material undesirably solvating the dry functional coating layer and/or adversely reacting with the dry functional coating layer). Additionally, in some embodiments it may be desirable to include more than one dry functional coating layer. In such an embodiment, after the first functional coating has dried and/or cured, one or more additional functional coating materials (e.g., in liquid form) may be coated directly onto at least a portion of the first dry functional coating layer and subsequently dried to provide one or more additional dry functional coating layers. Once all the desired dry functional coating layers have been applied and dried, the adhesive material may be coated onto the outermost dry functional coating layer.

As generally described above, will be appreciated that with any of the embodiments herein, more than one functional layer may be included. For example, after a first functional layer has been coated (e.g., either onto a release liner and/or onto the adhesive layer) and dried to form a first dry functional coating layer (e.g., either covering the entirety of the release liner or adhesive layer or covering only a portion of the release liner or adhesive layer), a subsequent functional coating layer may be coated onto the first dry functional coating layer, and may be dried to form a second dry function coating layer (e.g., either covering the entirety of the first dry functional coating layer and/or covering at least a portion of one or more of the first dry functional coating layer, the release liner, and/or the adhesive layer). One or more additional functional coating layers may be formed in a generally similar manner to provide a tape or adhesive material have a desired number and arrangement of dry functional coating layers.

Having described the illustrative examples of the present disclosure, it will be apparent that modifications and variations thereof are possible without departing from the scope of this invention as set forth in the claims that follow.

What is claimed is:

1. An adhesive tape comprising of:
a release liner having an outward-facing, major surface and an inward-facing, major surface;
a functional coating layer, in a dry state, applied to the inward-facing, major surface of the release liner; and
an adhesive layer directly laminated to the functional coating layer opposite the release liner.

2. The tape of claim 1, wherein the functional coating layer comprises an electrically conductive backplane for an electroluminescent lamp.

3. The tape of claim 1, wherein the functional coating layer comprises a print receptive coating.

4. The tape of claim 3, wherein the overall thickness of the tape is between about 1 mil to about 6 mil.

5. The tape of claim 1, wherein the wherein the functional coating layer comprises a protective coating.

6. The tape of claim 1, wherein the wherein the functional coating layer comprises one or more of an electrically conductive material, an insulator, and a dielectric material.

7. An adhesive material comprising of:
a release liner having an outward-facing, major surface and an inward-facing, major surface;
an adhesive layer applied to the inward-facing, major surface of the release liner; and
a functional coating layer, in a dry state, directly laminated to the adhesive layer opposite the release liner.

8. The adhesive material according to claim 7, wherein the functional coating layer includes a print receptive coating.

9. The adhesive material according to claim 7, wherein the functional coating layer includes an electrically conductive backplane for an electroluminescent lamp.

10. The adhesive material according to claim 7, wherein the functional coating layer includes a protective coating.

11. The adhesive material according to claim 7, wherein the functional coating layer includes one or more of an electrically conductive material, an insulator, and a dielectric material.

12. A method of making a laminated tape comprising:
providing an adhesive layer directly applied to a first release liner;
providing a functional coating, in a dry state, directly applied to a second release liner; and
laminating the adhesive layer directly to the functional coating opposite the second release liner.

13. The method of claim 12, further comprising removing either of the first release liner or the second release liner from a respective one of the adhesive layer and the functional coating.

14. The method of claim 13, wherein the functional coating comprises a print receptive coating and removing comprises removing the first release liner.

15. The method of claim 13, wherein the functional coating comprises an electrically conductive backplane for an electroluminescent lamp, and removing comprises removing the second release liner.

16. The method of claim 12, wherein providing the functional coating, in a dry state, directly applied to a second release liner comprises coating a liquid functional coating on the second release liner, and drying the liquid functional coating.

17. The method of claim 12, wherein providing the adhesive layer directly applied to a first release liner comprises coating an adhesive material to the first release liner to form the adhesive layer.

18. The method of claim 12, wherein the coating of the adhesive material comprises one or more of roll coating, knife coating, rod coating, blade coating, spray coating, and curtain coating.

19. A method of making a laminated tape comprising:
providing an adhesive layer directly applied to a release liner;
applying a first liquid functional coating directly to the adhesive layer; and
drying the first liquid functional coating to provide a first functional coating in a dry state laminated directly to the adhesive layer.

20. The method of claim 19, further comprising:
applying at least a second liquid functional coating directly to the first functional coating in the dry state; and
drying the second liquid functional coating to provide the second functional coating in a dry state laminated directly to the first functional coating the dry state.

21. A method of making a laminated tape comprising:
applying a first liquid functional coating to a release liner;
drying the first liquid functional coating to provide a first functional coating in a dry state; and
applying an adhesive layer directly to the first functional coating in the dry state to provide the adhesive layer directly laminated to the first function coating in the dry state.

22. The method of claim 21, wherein applying the first liquid functional coating to the release liner comprises:
applying a second liquid functional coating to the release liner;
drying the second liquid functional coating to provide a second functional coating in a dry state; and
applying the first liquid functional coating to the second functional coating in the dry state.
